(19) United States
(12) Patent Application Publication
(10) Pub. No.: US 2010/0042504 A1
(43) Pub. Date: Feb. 18, 2010

(54) SYSTEMS AND METHODS FOR EVALUATING ADVERTISING METRICS

(75) Inventors: Michael Shenfield, Richmond Hill (CA); Gaelle Martin-Cocher, Toronto (CA); Axel D. Ferrazzini, Toronto (CA)

Correspondence Address: Research in Motion Corp/SLW;Attn: Glenda Wolfe, Building 6, Brazos East, Suite 100, 5000 Riverside Drive, Irving, TX, 75039, US

(73) Assignee: Research in Motion Limited, ontario (CA)

(21) Appl. No.: 12/191,225

(22) Filed: Aug. 13, 2008

(51) Int. Cl. G06Q 30/00

(52) U.S. Cl. 705/14.73

(57) ABSTRACT

Systems and method for evaluating advertising metrics are disclosed and described.

### TECHNICAL FIELD

The present disclosure relates to computer systems and mobile devices and, in particular, to evaluating metrics for advertisements presented on computer systems and mobile wireless devices.

### BACKGROUND

Advertisements may be delivered to users of computer systems and mobile wireless devices using mobile advertising systems. One example of a mobile advertising system is described in the Open Mobile Alliance Mobile Advertising Architecture Specification Draft Version 1.0 available at http://www.openmobilealliance.org.

In most mobile advertising systems, the amount that an advertiser pays for an advertisement is often based on the number of times users interact with the advertisement or on the number of Ad impression. Some examples of user interaction include, but are not limited to viewing, clicking on, utilizing or some other form of interaction with the ad that can be measured.

However, there are many ways that user interaction with an advertisement may be faked in order to increase the amount the advertiser will pay for the advertisement. For example, an application program may request an advertisement for viewing by a user and return metrics representing a number of times the ad was viewed by the user without actually displaying the advertisement to the user.

Because faked or artificially inflated metrics mean that an advertiser may be paying extra for the advertisement, improvements in the evaluation of advertising metrics provide advertisers with more confidence in the validity of the metrics.

### SUMMARY

In example embodiments of the present disclosure, devices, systems, methods, and machine-readable media are provided for evaluating advertising metrics.

A method of evaluating advertising metrics may include, but does not require, receiving advertising metrics from an application handling advertisements, augmenting the advertising metrics with data from an advertising client, and validating the advertising metrics

Another method of evaluating advertising metrics may include, but does not require, receiving advertising metrics from an application handling advertisements, examining a level of trustworthiness for the application, and validating the advertising metrics if the level of trustworthiness is not sufficient.

A method of determining the trustworthiness of an application may include, but does not require, determining whether an application is trusted or un-trusted, and assigning a level of trustworthiness to the application.

Another method of determining a level of trustworthiness for an application may include, but does not require, receiving information about an application, and applying heuristics to the information to determining a level of trustworthiness for the application.

A method of reporting advertising metrics may include, but does not require, receiving advertising metrics from an application, creating an augmented report comprising the advertising metrics provided by the application and advertising metrics locally available at an advertising client, and transmitting the augmented report to an advertising server.

A method of validating a metrics report from an application may include, but does not require, receiving an Ad Application report from an application, retrieving a trustworthiness value for the application, and using the trustworthiness value for the application and applied heuristics to determine a trustworthiness value for the Ad Application report.

Apparatus, systems, and machine-readable media are also disclosed that perform comparable functions as the methods discussed above.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

Various example embodiments are further described with reference to the following accompanying drawings.

FIG. 1 is a block diagram of an advertising system according to some embodiments.

FIG. 2 is a more detailed block diagram of the advertising client shown in FIG. 1 according to some embodiments.

FIG. 3 is a flow chart of various methods of evaluating advertising metrics according to some embodiments.

FIG. 4 is a block diagram of a mobile device in conjunction with which some embodiments of the disclosure may be implemented.

### DETAILED DESCRIPTION

Certain specific details are set forth in the following description and figures to provide a thorough understanding of various embodiments. Those of ordinary skill in the relevant art will understand that they can practice other embodiments without one or more of the details described below. In addition, the various methods are described by reference to a sequence of operations in the following disclosure; however, the description as such is for providing a clear implementation of embodiments of the disclosure, and the particular sequence described should not be taken as required.

In general, it is contemplated that the various devices, methods, and computer readable media disclosed herein will be implemented within a system for evaluating advertising metrics. Such a system may generally be described as a computer-implemented or a computerized system that includes one or more “subsystems” for evaluating advertising metrics in the manner described below.

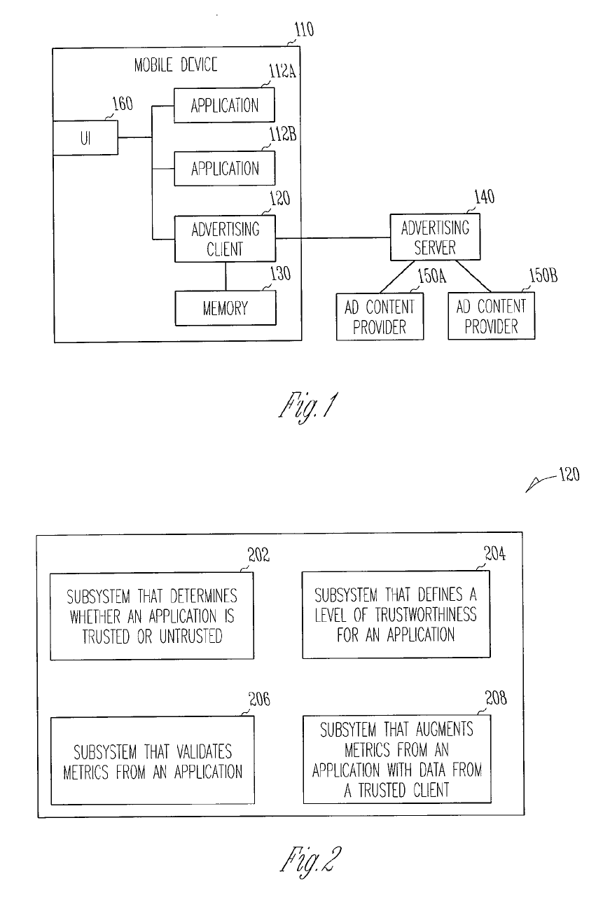

Example Operating Environment. FIG. 1 shows a block diagram illustrating logical components within a system for facilitating mobile advertisement. A mobile device 110 is adapted to consume or create content through an application 112 and to perform other related functions. When used herein, a mobile device is a general term that may include cellular telephones, mobile devices, pagers, laptop computers or other devices. An example mobile device is described below with reference FIG. 4.

In the embodiment of FIG. 1, a mobile device 110 comprises one or more applications 112A and 112B, and an advertising client 120. The use of applications 112 are merely meant for simplification and in practice multiple applications may be installed on the mobile device 110.

Applications 112A and 112B (referred to throughout the document as 112 for either a single application or multiple applications) represent applications that utilize advertisements. Examples may include an advertisement enabled email application in which advertisements are inserted into/above email messages, a web browser showing web pages into/above which advertisements can be inserted, instant messaging applications into/above which advertisements can be inserted, video or multimedia players which can have advertisements therein, and so on.

In the embodiment of FIG. 1, an advertising client 120 communicates with application 112 over an application program interface (API) and can further communicate with an advertising server 140, for example through a communications subsystem on mobile device 110.

Advertising client 120 may further communicate with memory on a mobile device 110. Such memory is shown as memory 130 in FIG. 1. Such communication may for example proceed through a processor and a bus.

Advertising server 140 may be responsible for selecting and/or providing advertisements from advertising content providers to appropriate devices. In one embodiment, the advertising server 140 may also be responsible for delivering advertisements to mobile device 110. As will be appreciated this may be done through a pull system in which an advertising client 120 requests ads from advertising server 140. Alternatively, this may be done on a push system in which advertising server 140 decides that mobile device 110 should receive certain ads and pushes these ads to advertising client 120.

Further, advertisements may be pushed on the fly. In other words, the advertisements may be obtained from advertising server 140 as they are requested by application 112. In alternative configurations the advertising server 140 may provide ads to mobile device 110 which are stored within memory 130 of the mobile device. This may facilitate the transfer of ads when network conditions are suitable for data transfer. Such network conditions may include a low cost period such as in the middle of the night or when the mobile device 110 is connected to a network through means such as a USB connection through a computer or through a wireless local area network (WLAN) such as WiFi.

An ad content provider, as illustrated by ad content providers 150A, 150B in FIG. 1, may be an ad content provider with an established business relationship with advertising server 140.

In one embodiment, when a new ad content provider, such ad content provider 150, registers with advertising server 140 it may provide information about types of advertisements that it is providing. This may enable advertising server 140 to target the user of mobile device based on the characteristics of the ads. For example, mobile device 110 may have a profile that it may provide to advertising server 140 with information about the preferences of a user of mobile device 110. As such, mobile advertising server may, in this embodiment, match the user preferences with advertisements characteristics provided by ad content provider 150.

In one embodiment, mobile device 110 may include a profile stored in memory 130. A profile may be created based on user questionnaires when the user first signs up to use the mobile device or may be based on some sort of watching application which tracks the user's content consumption and creation to build a profile.

Under a traditional model of mobile advertising, mobile advertising server 140 may provide an ad to mobile client 120. Application 112 may be loaded onto mobile device 110 and may be provided by various third party creators of applications. In this case, the application 112 may request the ad from an advertising client 120 and provides statistics on the consumption of the ad back to advertising client 120. The problem with this is that application 112 may be created by any third party and thus may not be honest about the ad consumption metrics that it provides back to advertising client 120 or advertising server 140.

The present disclosure therefore provides for a trusted advertising client 120 that is adapted to evaluate advertising metrics from both trusted and un-trusted applications 112. In some embodiments, advertising client 120 and/or advertising server 140 may operate with applications 112 in accordance with one or more of the standards or specifications of the Open Mobile Alliance (http://www.openmobilealliance.org).

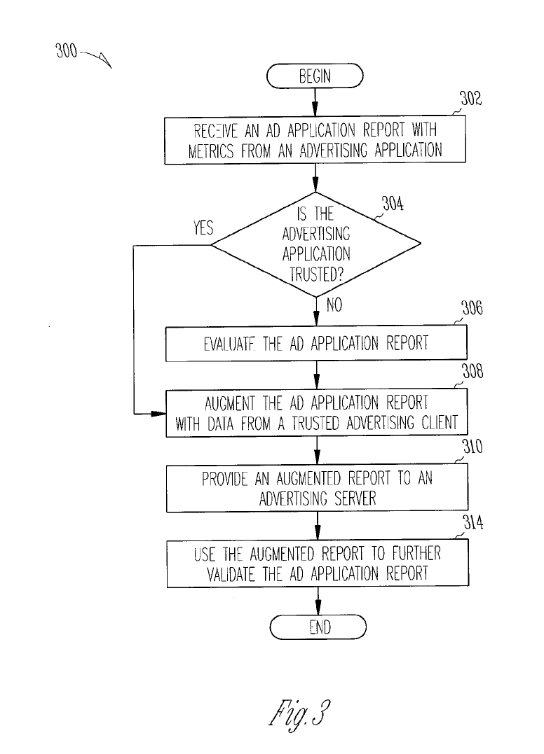

FIG. 2 is a more detailed block diagram of the advertising client 120 shown in FIG. 1 according to some embodiments. In an example embodiment, the advertising client 120 (also referred to as Ad Client 120) comprises at least one subsystem that evaluates advertising metrics. In the example embodiment shown in FIG. 2, the advertising client comprises a subsystem that determines whether an application is trusted or un-trusted 202, a subsystem that defines a level of trustworthiness for an application 204, a subsystem that validates metrics from an application 206, and a subsystem that augments metrics from an application with data from a trusted client 208.

In some embodiments, the subsystem 202 determines whether an application 112 (also referred to as Ad Application 112 or Advertising Application 112) is trusted or un-trusted. In some embodiments, whether an Ad Application 112 is trusted or un-trusted may be based on one or more technical parameters or business agreements.

A trusted application is an application for which the Advertising Client 120 does not need to verify the metrics that are reported by the application. For example, a trusted application may be an application provided by a manufacturer of a mobile device to display ads on a user interface ribbon on the mobile device. This example application does not deal with user actions and does not display active content (e.g. content associated with Javascript) that can alter the metrics that are reported from the application.

An un-trusted application is an application for which the metrics that are reported to the Ad Client 120 are not trusted. For example, an un-trusted application may be a browser application that displays ads along with active content. The active content (e.g. Javascript) may alter the metrics reported by the un-trusted application to the Ad Client 120 by faking user interactions with the displayed ads. In some embodiments, the Ad Client 120 verifies the metrics received from an un-trusted application. In other embodiments, the advertising server 140 (also referred to as Ad Server 140) may verify the metrics provided by an un-trusted application.

In some embodiments, metrics may be any data or report(s) on user interactions with an advertisement. In some embodiments, user interactions may be as simple as an indication that the ad was displayed on a display device or played on an audio component. In other embodiments, user interactions may be more sophisticated interactions such as the user clicking through an advertisement or interacting with the advertisement in other ways. Embodiments of the disclosure are not limited to metrics for any particular user interactions. User interactions may comprise any action involving an advertisement including, but not limited to, user interactions such as:

a. Click to contact (e.g.: make calls, send MMS, SMS, Email etc.);

b. Click to ask to be contacted (e.g.: receive calls, MMS, SMS, Email etc.);

c. Click to locate: the User obtains more information about the advertiser based on the location (e.g.: advertiser's shops near its location);

d. Click to enter branded Mobile Web site: the User is redirected to the Advertiser's web-site (e.g.: to fill out some forms, to get more information, etc);

e. Click to receive coupon: the User receives a discount coupon that might be stored in their device;

f. Click-to-buy: the User buys the Advertiser products;

g. Click to download content: the User receives Advertiser's related content (e.g.: ringtone, brochure, video, etc);

h. Click to forward content advertisements: the User forwards the ad directly or through Service Provider to another User;

i. Forwarding Ad;

j. Sending notification;

k. Click to request: the User requests some action from the Advertiser with some parameters associated if needed (e.g.: opt in for winning prizes, order brochure by supplying postal or email addresses, etc);

l. Click-to-discard: the User communicates to the Service Provider that the advertisement is not of his/her interest (e.g.: he/she refuses a discount coupon); or

m. Click to save or bookmark an ad.

The actions listed above are examples, but not an exhaustive list, of actions for which the Ad Application 112 may record statistics and report the statistics (or metrics) to an Ad Client 120. According to some embodiments of the disclosure, the Ad Client 120 or the Ad Server 140 may validate metrics from Ad Applications using the subsystem that validates metrics from an application 206.

Referring back to the subsystem that determines whether an application is trusted or un-trusted 202, the Ad Client 120 is not limited to any specific method to determine whether an Ad Application 112 is trusted or un-trusted.

In some embodiments, the Ad Client 120 uses an identification number to determine if an Ad Application 112 is trusted or not. For example, the Ad Client 120 may be provisioned with a list of IDs or Uniform Resource Identifiers (URIs) for trusted applications. In another example, the Ad Client 120 may receive application IDs for trusted applications from an Ad service provider and/or from a mobile device manufacturer (e.g. stored in non-volatile memory). In still another example, the application IDs may be securely provided to a mobile device at runtime (e.g. using a Device Management “DM” mechanism).

In other embodiments, the Ad Client 120 may deem an Ad Application 112 as trusted if the Ad Application 112 has an appropriate certificate issued by certification authority trusted by an Ad service provider.

In further embodiments, the Ad Client 120 may use a validation Uniform Resource Locator (URL) provided by the Ad Application 112 for a certification authority to confirm that an Ad Application 112 is trusted. The validation URL may be predefined or provisioned (e.g. via DM) to the Ad Client 120. The Ad Client 120 may use the validation URL to validate application trustworthiness by providing application information to the certification authority. In an example embodiment, the application information may be obtained during registration of the Ad Application 112 with the Ad Client 120.

In still another embodiment, the Ad Client 120 may have a controlled Application Programming Interface (API) for reporting advertisement metrics. The Ad Client 120 may limit rights to access the API to only Ad Applications 112 having an appropriate certificate. Only the Ad Applications 112 having access to the API are considered trusted applications for this example.

Embodiments of the disclosure are not limited to the examples listed above for determining whether an Ad Application 112 is trusted or un-trusted. The examples are provided for illustrative purposes only. Additional or different methods for identifying that an Ad Application 112 is considered by an Ad Client 120 to be a trusted application may be used.

After the Ad Client 120 determines whether an Ad Application 112 is trusted or un-trusted, the Ad Client 120 may store information indicating whether the application is trusted or un-trusted. In some embodiments, a Boolean attribute may be used to identify whether an Ad Application 112 is trusted or un-trusted. The Boolean attribute, or any other means of identifying whether the application is trusted or untrusted, may be referenced by the subsystems 204, 206, and 208 shown in FIG. 2.

Referring back to example embodiment FIG. 2, the Ad Client 120 may also comprise a subsystem that defines a level of trustworthiness for the application 204. If the Ad Application 112 is identified as un-trusted by subsystem 202, then the Ad Client 120 may use the subsystem 204 to define a level of trustworthiness for the Ad Application 112.

In some embodiments, the subsystem 204 may use information provided by an Ad Application 112 when determining the level of trustworthiness. For example, an Ad Application 112 may register with the Ad Client 120 in order to be able to obtain advertisements. During the process of registering, the Ad Application 112 may provide information to the Ad Client 120 such as:

a. Application provider (The application provider may be the source of the Ad Application 112 such as a manufacturer, an application service provider, a third party, and so on.)

b. Ad Service Provider Service Identification Number (An Ad Service Provider Service ID may indicate that the Ad Application 112 is a result of a business agreement with the Ad service provider.)

c. Application manifest describing application properties (The application properties may describe how the application will handle ads provided to the Ad Application 112 by the Ad Client 120. For example, the Ad Application 112 may use the ads for viewing only or the Ad Application 112 may allow the user to interact with the ads).

In some embodiments, the Ad Client 120 may also apply various heuristics based on the information provided by the Ad Application 112 during registration in order to determine the level of trustworthiness for the Ad Application 112. In addition, the Ad Client 120 may use information available from external sources including information preconfigured on the wireless device.

In one embodiment, a level of trustworthiness is represented with a trustworthiness indicator value. The trustworthiness indicator value is any indicator of the level of trustworthiness of an Ad Application 112. In one example, the trustworthiness indicator value may be represented with one or more labels such as “Trusted”, “Conditionally Trusted”, “Un-Trusted” and the like. In another example, the trustworthiness indicator value may be a numeric value selected from a range of numbers representing different levels of trustworthiness.

The following is an example of assigning a numeric value to represent a trustworthiness indicator value for an application. If the application is determined to be trusted (as identified by subsystem 202 described above) the trustworthiness indicator value is set to “1”. If the application is determined to be “conditionally” trusted (e.g., based on local heuristics applied after registration of the application), the trustworthiness indicator value is assigned a number between “0” and “1”. If the application is determined to be completely un-trusted (e.g., a rogue application designed to generate fake advertisement metrics), the application trustworthiness indicator value is set to “0”.

Embodiments of the disclosure are not limited to the examples listed above for trustworthiness indicator values. The examples are provided for illustrative purposes only. Additional or different methods for defining a level of trustworthiness may be used. In some embodiments, an Ad Client 120 or an Ad Server 140 may use the level of trustworthiness of an Ad Application 112 and/or the trustworthiness indicator value for the Ad Application 112 when validating the metrics provided by the Ad Application 112.

In some embodiments, an Ad Client 120 or an Ad Server 140 may maintain a “trustworthiness threshold” for an Ad Application 112. The trustworthiness threshold may be any indicator of a desired level of trustworthiness. The trustworthiness threshold may be represented in any manner that the level of trustworthiness for an Ad Application 112 is represented (e.g., a label, a numeric value, etc.) In an example embodiment in which a level of trustworthiness for an Ad Application 112 is represented as a range of numeric values, the trustworthiness threshold may be a value above which the application is considered to be “trusted” (assuming that higher numbers in the range represent a higher level of trustworthiness). In this example embodiment, an Ad Client 120 or an Ad Server 140 should validate metrics from an Ad Application if the Ad Application's level of trustworthiness is below the value of the trustworthiness threshold. In another example, if upon applied heuristics the Ad Client 120 identifies that trustworthiness for an Ad Application is value is 0.7 and the threshold level defined by a Service Provider is 0.8, then the Ad Application is deemed as un-trusted. In contrast, if the trustworthiness value for an Ad Application is 0.9 and the threshold level is 0.8, then the Ad Application is deemed as trusted.

Referring back to the example embodiment in FIG. 2, the Ad Client 120 also comprises a subsystem that validates metrics from an Ad Application (subsystem 206). In addition, in some embodiments, the subsystem 206 that validates metrics from an Ad Application 112 may also define a level of trustworthiness for the metrics provided by the Ad Application 112.

The subsystem 206 performs operations on the metrics provided by the Ad Application 112 in order to detect metrics that are fake, artificially inflated, or otherwise not representative of actual user interactions with an advertisement through the Ad Application 112. The operations performed may be any operation or operations that check or prove the validity or accuracy of the metrics provided by the Ad Application 112.

In some embodiments, the Ad Client 120 validates metrics received from all Ad Applications 112 reporting to the Ad Client 120. In other embodiments the Ad Client 120 validates metrics received from less than all of the Ad Applications 112 reporting to the Ad Client 120. For example, the Ad Client 120 may use subsystem 206 to validate metrics received only from Ad Applications 112 identified as un-trusted or conditionally trusted by subsystem 202. In still other embodiments, the Ad Client 120 does not validate metrics from any Ad Applications 112, and instead an Ad Server 140 validates the metrics from the Ad Applications 112.

When the Ad Server 140 validates metrics from the Ad Application 112, the operations performed by the Ad Server 140 may be, but are not always, performed as a substitute for validating the metrics by the Ad Client 120. In some embodiments, both the Ad Client 120 and the Ad Server 140 may validate the metrics from the Ad Application 112. When the Ad Client 120 and the Ad Server 140 both validate metrics from an Ad Application 112, the Ad Client 120 and the Ad Server 140 may perform the same operations, or one may perform additional or different operations than the other.

In some embodiments, the Ad Client 120 receives the metrics from an Ad Application 112 in the form of an Ad Application Report. An Ad Application Report may be any mechanism used by an Ad Application 112 to provide advertising metrics to an Ad Client 120 or an Ad Server 140. In some embodiments, the Ad Application Report comprises one or more files containing data representing advertising metrics.

To validate the Ad Application report, the subsystem 206 may perform operations to compare data that was generated by the Ad Application 112 (e.g., the data in the Ad Application Report) against data that was not generated by the application 112 (e.g., data locally available to the Ad Client 120). In one embodiment, the Ad Application Report may be considered valid if there are no discrepancies between the metrics in the Ad Application Report and the metrics maintained by the Ad Client 120.

In some embodiments, the operations performed by subsystem 206 to validate the Ad Application report may comprise operations to compare a value of one or more parameters known to Ad Client 120 with a value of the same parameters provided in the Ad Application report. Some examples of parameters that may be known to an Ad Client 120 and provided in an Ad Application Report include, but are not limited to:

i. Ad Application manifest known to the Ad Client 120 (e.g. provided at registration)

ii. Count of the number of Ads passed to Ad Application 112 by the Ad Client 120 (as well as additional information passed to the Ad Client 120 e.g. context such as time, location, etc.)

iii. Frequency of the Ad actions reported

iv. Report validation history for an Ad Application 112

v. Ad metadata

In addition, in some embodiments, when validating an Ad Application Report subsystem 206 may consider the level of trustworthiness of the Ad Application 112 when determining which or how many parameters to compare. For example, if the Ad Application 112 is conditionally trusted (i.e., if 1>Ad Application trustworthiness indicator value>0), then the Ad Application Report provided by the Ad Application 112 may be validated against just one of the parameters described above for example. However, in the same example, if the Ad Application 112 is completely un-trusted (e.g., if application trustworthiness indicator value=0), the Ad Application Report may be validated against all of the parameters listed above.

Embodiments of the disclosure are not limited to the examples parameters listed above against which to validate an Ad Application Report. The examples are provided for illustrative purposes only. Additional or different parameters may be used to validate an Ad Application Report.

In addition to validating the Ad Application Report, subsystem 206 may also define a level of trustworthiness for an Ad Application Report. In some embodiments, the level of trustworthiness for the Ad Application Report may be based on an application trustworthiness indicator value alone or in combination with applied heuristics. In some embodiments, the level of trustworthiness may be defined a subsystem 206 on the Ad Client 120. In other embodiments, an Ad Server 140 may define the level of trustworthiness.

For example, if an Ad Application 112 is a trusted application, then the level of trustworthiness of an Ad Application Report provided by the Ad Application 112 may be assigned the same value as the level of trustworthiness of the Ad Application. In other words, if the Ad Application 112 is determined to be a trusted application by subsystem 202, then subsystem 206 may consider an Ad Application Report prepared by that Ad Application 112 to be trusted according to some embodiments of the disclosure.

In another example, for either a conditionally trusted Ad Application 112 or a completely un-trusted Ad Application, the trustworthiness of an Ad Application Report provided by the application may also be evaluated based on additional heuristics (e.g. evaluation of metrics against ad metadata). The level of trustworthiness of the Ad Application Report may be determined by applying heuristics to parameters that are in the Ad Application Report and that are also known to the Ad Client 120. If the Ad Application Report indicates that a specific Advertisement X was clicked to download content, but the metadata known to Ad Client 120 for Advertisement X indicates that Advertisement X only allows click to call or an impression applying heuristics to the parameters in the Ad Application Report may identify a discrepancy in the Ad Application Report. As a result of the applied heuristics, the trustworthiness value of the Ad Application Report may be assigned to 0 to indicate that the Ad Application Report is un-trusted.

Additionally, in some embodiments, even for a trusted Ad Application 112 the Ad Client 120 may still apply heuristics to some of the Ad Application Reports from a trusted Ad Application 112 in order to validate or confirm the trusted status of application or to fine-tune the heuristics output for a Ad Application Report.

In some embodiments, an Ad Client 120 or an Ad Server 140 may also maintain a “trustworthiness threshold” for an Ad Application Report. The trustworthiness threshold level for an Ad Application Report may be the same as a trustworthiness threshold level for an Ad Application 112 or it may be different.

Embodiments of the disclosure are not limited to the examples listed above for validating metrics from an Ad Application. The examples are provided for illustrative purposes only. For example, additional or different types of parameters may be checked to validate metrics from an Ad Application or to assign a level of trustworthiness to the metrics.

Referring back to the example embodiment in FIG. 2, the Ad Client 120 may also comprise a subsystem that augments metrics from an Ad Application (subsystem 208). When an Ad Client 120 receives metrics (e.g., an Ad Application Report) from an Ad Application 112, the Ad Client 120 may use subsystem 208 to augment the metrics provided by the Ad Application 112 with additional data provided by the Ad Client 120.

In some embodiments, the data provided by the Ad Client 120 may comprise, but is not limited to, the following:
metrics related to information locally available at the Ad Client
an indication of whether an Ad Application 112 is trusted or not
a trustworthiness indicator value for an Ad application 112
a trustworthiness value for an Ad Application Report or any other metrics from an Ad Application 112
an indication of whether or not heuristics were performed to evaluate the trustworthiness of the Ad Application Report or any other metrics from the Ad Application 112
an indication whether or not the Ad Application Report was discarded after validation

In some embodiments, the data from the Ad Client 120 may be maintained as an Ad Client Report. The Ad Client Report may comprise one or more files containing data representing advertising metrics locally available to the Ad Client 120.

The subsystem 208 sends the Ad Application Report and the data from the Ad Client 120 to the Ad Server 140. In some embodiments, the Ad Application Report and the data from the Ad Client 120 (e.g., the Ad Client Report) are combined by subsystem 208 to form an Augmented Report, which is sent to the Ad Server 140. Because the Ad Client 120 is a trusted component of the system the Ad Server 140 may take further actions to validate the metrics provided by the Ad Application (which may be trusted or un-trusted) using the information provided by the Ad Client 120.

Embodiments of the disclosure are not limited to the examples listed above for data that may be provided to an Ad Server 140 from a trusted Ad Client 120. The examples are provided for illustrative purposes only. Additional or different types of data may be used to augment an Ad Application Report prepared by an Ad Application.

An example embodiment of a trusted Ad Client 120 has been described by reference to FIG. 2. The Ad Client 120 shown in FIG. 2 comprises a subsystem that determines whether an application is trusted or un-trusted 202, a subsystem that defines a level of trustworthiness for an application 204, a subsystem that validates metrics from an application 206, and a subsystem that augments metrics from an application with data from a trusted client 208. However, an Ad Client 120 is not limited to these particular subsystems; rather, the subsystems are provided for illustrative purposes only. In alternative embodiments, the Advertising Client may comprise additional or different subsystems for evaluate advertising metrics.

For example, an Ad Client 120 may also comprise a subsystem to refine the trustworthiness indicator value of an Ad Application 112 based on the results of heuristics applied to multiple Ad Application Reports from the particular Ad Application 112. In some embodiments, the Ad Client 120 may create a “cumulative” or “historic” trustworthiness indicator value to be used for future Ad Application Reports from the same Ad Application 112. For example, any suspicious Ad Application Report may either reduce the “historic” trustworthiness indicator value or reset the “historic” trustworthiness indicator value to 0 (as in the example calculation shown below).

The following is an example calculation for an Ad Application trustworthiness value using the Ad Application Report validation history:

Hₜ is the Cumulative (“historic”) trustworthiness value for reports from a given Ad Application 112. For this example, assume Hₜ=A. The Ad Client 120 applies validation heuristics to the latest Ad Application Report (report #N). If the result of the validation heuristics indicates that the Ad Application Report is “valid”, then the Ad Client 120 modifies Hₜ to A+(1−A)/N. However, if the result of the validation heuristics indicates that the Ad Application Report is “fake”, then the Ad Client 120 resets Hₜ to zero. Upon calculation, the Ad Client 120 may report the new Hₜ value as a trustworthiness value of the latest report to the Ad Server 140 (or may includes this parameter along with Augmented Report).

Example embodiments of systems for evaluating advertising metrics have been described by reference to FIGS. 1, 2 and 3. These systems may generally be described as computer-implemented or computerized systems for evaluating advertising metrics. An advertising client may evaluate advertising metrics according the example methods described in the next section.

Methods. In this section, particular methods of example embodiments are described by reference to a series of flow charts. In one embodiment, the methods to be performed constitute computer programs made up of computer-executable instructions.

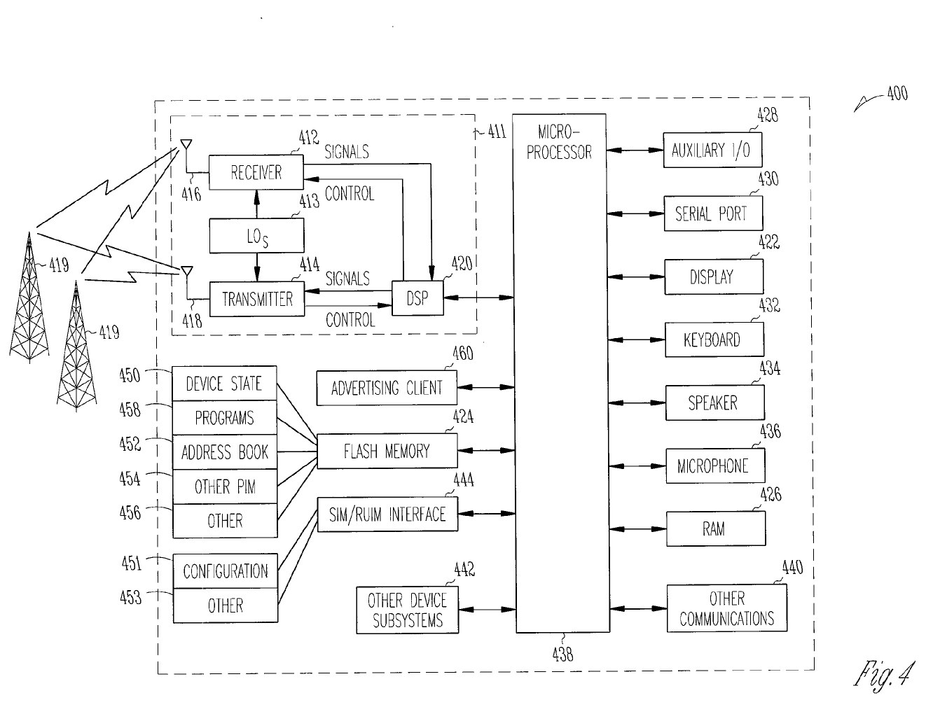

FIG. 3 is a flow chart of various methods of evaluating advertising metrics according to some embodiments. As shown in FIG. 3, an Ad Application Report comprising metrics from an Advertising Application is received by an Ad Client (block 302).

In one embodiment, when the Ad Client receives the Ad Application Report, the Ad Client checks to see if the Ad Application is considered trusted or un-trusted (block 304). In addition, if the Ad Application is un-trusted, the Ad Client may optionally check the level of trustworthiness currently assigned to the Ad Application (not shown in FIG. 3).

If the Ad Application is un-trusted, the Ad Client evaluates the Ad Application Report (block 306). In some embodiments, evaluating the Ad Application Report comprises validating the metrics in the Ad Application Report. In some embodiments, evaluating the Ad Application Report may also comprise defining a level of trustworthiness for the Ad Application Report.

Regardless of whether the Ad Application is trusted or un-trusted, the Ad Client my also augment the data in the Ad Application Report with additional data available to the Ad Client (block 308). The Ad Client provides an Augmented Report to an Ad Server (block 310). In some embodiments, the Ad Server may use the Augment Report to further validate the Ad Application Report (block 314).

Example Hardware Implementation. This section provides an overview of an example mobile device in conjunction with which embodiments of the disclosure can be implemented.

FIG. 4 is a block diagram of a mobile device in conjunction with which embodiments of the disclosure can be implemented. In some embodiments, mobile device 400 may by a two-way wireless communication device having at least voice and data communication capabilities. Mobile device 400 may have the capability to communicate with other computer systems on the Internet. Depending on the exact functionality provided, the wireless device may be referred to as a data messaging device, a two-way pager, a wireless e-mail device, a cellular telephone with data messaging capabilities, a wireless Internet appliance, or a data communication device, and so on.

When mobile device 400 is enabled for two-way communication, it may incorporate a communication subsystem 411, including both a receiver 412 and a transmitter 414, as well as associated components such as one or more embedded or internal, antenna elements 416 and 418, local oscillators (LOs) 413, and a processing module such as a digital signal processor (DSP) 420. The particular design of the communication subsystem 411 may vary depending on the communication network in which the device is intended to operate.

Network access requirements may also vary depending upon the type of network 419. In some CDMA networks, network access is associated with a subscriber or user of mobile device 400. A CDMA mobile device may require a removable user identity module (RUIM) or a subscriber identity module (SIM) card in order to operate on a CDMA network. The SIM/RUIM interface 444 may be similar to a card-slot into which a SIM/RUIM card can be inserted and ejected like a diskette or PCMCIA card. The SIM/RUIM card may have approximately 64K of memory and may hold configurations 451 and other information 453 such as identification, and subscriber related information.

When network registration or activation procedures have been completed, mobile device 400 may send and receive communication signals over the network 419. As illustrated in FIG. 4, network 419 may consist of multiple base stations communicating with the mobile device. For example, in a hybrid CDMA 1× EVDO system, a CDMA base station and an EVDO base station may communicate with the mobile device and the mobile device may be connected to both simultaneously. The EVDO and CDMA 1× base stations may use different paging slots to communicate with the mobile device.

Signals received by antenna 416 through communication network 419 may be input to receiver 412, which may perform such common receiver functions as signal amplification, frequency down conversion, filtering, channel selection and the like, and in the example system shown in FIG. 4, analog to digital (A/D) conversion. A/D conversion of a received signal allows more complex communication functions such as demodulation and decoding to be performed in the DSP 420. In a similar manner, signals to be transmitted are processed, including modulation and encoding for example, by DSP 420 and input to transmitter 414 for digital to analog conversion, frequency up conversion, filtering, amplification and transmission over the communication network 419 via antenna 418. DSP 420 not only processes communication signals, but also provides for receiver and transmitter control. For example, the gains applied to communication signals in receiver 412 and transmitter 414 may be adaptively controlled through automatic gain control algorithms implemented in DSP 420.

Mobile device 400 may include a microprocessor 438 that controls the overall operation of the device. Communication functions, including at least data and voice communications, may be performed through a communication subsystem 411. Microprocessor 438 may also interact with further device subsystems such as the display 422, flash memory 424, random access memory (RAM) 426, auxiliary input/output (I/O) subsystems 428, serial port 430, one or more keyboards or keypads 432, speaker 434, microphone 436, other communication subsystem 440 such as a short-range communications subsystem and any other device subsystems generally designated as 442. Serial port 430 may include a USB port or other port known to those in the art.

Some of the subsystems shown in FIG. 4 may perform communication-related functions, whereas other subsystems may provide “resident” or on-device functions. Notably, some subsystems, such as keyboard 432 and display 422, for example, may be used for both communication-related functions, such as entering a text message for transmission over a communication network, and device-resident functions such as a calculator or task list.

Operating system software used by the microprocessor 438 may be stored in a persistent store such as flash memory 424, which may instead be a read-only memory (ROM) or similar storage element (not shown). The operating system, specific device applications, or parts thereof, may be temporarily loaded into a volatile memory such as RAM 426. Received communication signals may also be stored in RAM 426.

As shown, flash memory 424 may be segregated into different areas for both computer programs 458 and program data storage 450, 452, 454 and 456. These different storage types indicate that each program can allocate a portion of flash memory 424 for their own data storage requirements. Microprocessor 438, in addition to its operating system functions, may enable execution of software applications on the mobile device. A predetermined set of applications that control basic operations, including at least data and voice communication applications for example, may be installed on mobile device 400 during manufacturing. Other applications could be installed subsequently or dynamically.

An example software application may be a personal information manager (PIM) application having the ability to organize and manage data items relating to the user of the mobile device such as, but not limited to, e-mail, calendar events, voice mails, appointments, and task items. One or more memory stores may be available on the mobile device to facilitate storage of PIM data items. Such PIM application may have the ability to send and receive data items, via the wireless network 419. In one embodiment, the PIM data items may be seamlessly integrated, synchronized and updated, via the wireless network 419, with the mobile device user's corresponding data items stored or associated with a host computer system. Further applications may also be loaded onto the mobile device 400 through the network 419, an auxiliary I/O subsystem 428, serial port 430, short-range communications subsystem 440 or any other suitable subsystem 442, and installed by a user in the RAM 426 or a non-volatile store (not shown) for execution by the microprocessor 438. Such flexibility in application installation increases the functionality of the device and may provide enhanced on-device functions, communication-related functions, or both. For example, secure communication applications may enable electronic commerce functions and other such financial transactions to be performed using the mobile device 400.

In a data communication mode, a received signal such as a text message or web page download may be processed by the communication subsystem 411 and input to the microprocessor 438, which may further process the received signal for output to the display 422, or alternatively to an auxiliary I/O device 428.

A user of mobile device 400 may also compose data items such as email messages for example, using the keyboard 432, which may be a complete alphanumeric keyboard or telephone-type keypad, in conjunction with the display 422 and possibly an auxiliary I/O device 428. Such composed items may then be transmitted over a communication network through the communication subsystem 411.

For voice communications, overall operation of mobile device 400 may be similar, except that received signals would may be output to a speaker 434 and signals for transmission may be generated by a microphone 436. Alternative voice or audio I/O subsystems, such as a voice message recording subsystem, may also be implemented on mobile device 400. Although voice or audio signal output may be accomplished primarily through the speaker 434, display 422 may also be used to provide an indication of the identity of a calling party, the duration of a voice call, or other voice call related information for example.

Serial port 430 in FIG. 4, may be implemented in a personal digital assistant (PDA)-type mobile device for which synchronization with a user's desktop computer (not shown) may be desirable, but is an optional device component. Such a port 430 may enable a user to set preferences through an external device or software application and may extend the capabilities of mobile device 400 by providing for information or software downloads to mobile device 400 other than through a wireless communication network. The alternate download path may for example be used to load an encryption key onto the device through a direct and thus reliable and trusted connection to thereby enable secure device communication. The serial port 430 may further be used to connect the mobile device to a computer to act as a modem.

Other communications subsystems 440, such as a short-range communications subsystem, may be a further optional component which may provide for communication between mobile device 400 and different systems or devices, which need not necessarily be similar devices. For example, the subsystem 440 may include an infrared device and associated circuits and components or a Bluetooth™ communication module to provide for communication with similarly enabled systems and devices.

In the embodiment of the present disclosure, an advertising client 460 communicates with processor 438 to provide the functionality as disclosed herein.

This has been a detailed description of some exemplary embodiments of the invention(s) contained within the disclosed subject matter. Such invention(s) may be referred to, individually and/or collectively, herein by the term “invention” merely for convenience and without intending to limit the scope of this application to any single invention or inventive concept if more than one is in fact disclosed. The detailed description refers to the accompanying drawings that form a part hereof and which show by way of illustration, but not of limitation, some specific embodiments of the invention, including a preferred embodiment. These embodiments are described in sufficient detail to enable those of ordinary skill in the art to understand and implement the inventive subject matter. Other embodiments may be utilized and changes may be made without departing from the scope of the inventive subject matter.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In the foregoing Detailed Description, various features are grouped together in a single embodiment for the purpose of streamlining the disclosure. This method of disclosure is not to be interpreted as reflecting an intention that any future claimed embodiments of the invention require more features than are expressly recited in each claim. Rather, any future claims may reflect inventive subject matter that lies in less than all features of a single disclosed embodiment.

It will be readily understood to those skilled in the art that various other changes in the details, material, and arrangements of the parts and method stages, which have been described and illustrated in order to explain the nature of this invention, may be made without departing from the principles and scope of the inventive subject matter.

What is claimed is:

1. A computerized system to evaluate advertising metrics, the computerized system comprising at least one subsystem that:
receives advertising metrics from an application handling advertisements;
augments the advertising metrics with data from an advertising client; and
validates the advertising metrics.

2. The computerized system of claim 1 further comprising at least one subsystem that determines a level of trustworthiness for the application.

3. The computerized system of claim 1 further comprising at least one subsystem that determines a level of trustworthiness for the advertising metrics.

4. The computerized system of claim 1, further comprising at least one subsystem that:
determining a level of trustworthiness for the application;
determining a historical level of trustworthiness for the advertising metrics;
and refining the level of trustworthiness for the application based on the historical level of trustworthiness of the advertising metrics.

5. A computerized method of evaluating advertising metrics, the method comprising:
receiving advertising metrics from an application handling advertisements;
examining a level of trustworthiness for the application; and
validating the advertising metrics if the level of trustworthiness is not sufficient.

6. The computerized method of claim 5, further comprising augmenting the advertising metrics with data from an advertising client.

7. The computerized method of claim 5 wherein the level of trustworthiness is a numeric value selected from a range of numbers representing different levels of trustworthiness.

8. The computerized method of claim 5 further comprising comparing the level of trustworthiness for the application to a trustworthiness threshold to determine if the level of trustworthiness for the application is sufficient.

9. A computerized system comprising at least one subsystem that:
determines whether an application is trusted or untrusted; and
assigns a level of trustworthiness to the application.

10. The computerized system of claim 9 further comprising at least one subsystem that uses a Boolean attribute to represent whether an application is trusted or untrusted.

11. The computerized system of claim 9, further comprising at least one subsystem that:
maintains a list of IDs for the applications that are trusted; and
checks the list of IDs to determine if the application is trusted or untrusted.

12. The computerized system of claim 9, further comprising at least one subsystem that:
receives a list of IDs for the applications that are trusted; and
checks the list of IDs to determine if the application is trusted or untrusted.

13. The computerized system of claim 12 wherein the list of IDs are received from an advertising service provider.

14. The computerized system of claim 9 wherein the list of IDs are received at runtime.

15. The computerized system of claim 9, wherein the application is trusted if the application has a certificate issued by a certification authority trusted by an advertising service provider.

16. The computerized system of claim 9, further comprising at least one subsystem that receives from the application a validation URL for a certification authority to confirm whether the application is trusted or untrusted.

17. A mobile device adapted to determine a level of trustworthiness, the mobile device comprising:
a processor;
a memory to store instructions, the instructions when executed cause the processor to
receive information about an application; and
apply heuristics to the information to determining a level of trustworthiness for the application.

18. The mobile device of claim 17 wherein receiving information is performed during registration of the application with an advertising client.

19. The mobile device of claim 17 wherein the information comprises a source of the application.

20. The mobile device of claim 17 wherein the information comprises an ID for an advertising service provider associated with the application.

21. The mobile device of claim 17 wherein the information comprises one or more properties of the application.

22. The mobile device of claim 17 further comprising representing the level of trustworthiness with a trustworthiness value.

23. A machine-readable medium having stored thereon instructions to cause a computer to perform a method of reporting advertising metrics, the method comprising:
receiving advertising metrics from an application;
creating an augmented report comprising the advertising metrics provided by the application and advertising metrics locally available at an advertising client; and
transmitting the augmented report to an advertising server.

24. The machine-readable medium of claim 23 wherein the augmented report further comprises an indication whether the application is trusted or untrusted.

25. The machine-readable medium of claim 24 wherein the augmented report further comprises a level of trustworthiness for the application.

26. The machine-readable medium of claim 24 wherein the augmented report further comprises a level of trustworthiness for the metrics report.

27. The machine-readable medium of claim 24 wherein the augmented report further comprises an indication whether heuristics were performed to evaluate the trustworthiness of the metrics report.

28. The machine-readable medium of claim 24 wherein the augmented report further comprises an indication whether the metrics report was discarded after validation.

29. A method of validating a metrics report from an application, the method comprising:
receiving an Ad Application report from an application;
retrieving a trustworthiness value for the application; and
using the trustworthiness value for the application and applied heuristics to determine a trustworthiness value for the Ad Application report.

30. The method of claim 29 wherein the applied heuristics comprise validating the metrics report against an application manifest available to an advertising client or to an advertising server.

31. The method of claim 29 wherein the applied heuristics comprise validating the metrics report against a count of advertisements passed to the application by the advertising client.

32. The method of claim 29 wherein the applied heuristics comprise validating the metrics report against a frequency or a quantity of advertising actions reported.

33. The method of claim 29 wherein the applied heuristics comprise validating the metrics report against a report validation history for the application.

34. The method of claim 29 wherein the applied heuristics comprise validating the metrics report against metadata for one or more advertisements.
